(19) United States
(12) Patent Application Publication
(10) Pub. No.: US 2025/0222538 A1
(43) Pub. Date: Jul. 10, 2025

(54) LASER MANUFACTURING MICROSTRUCTURE PARTITION REGULATION AND CONTROL DEVICE AND METHOD BASED ON MATRIX MODULAR TEMPERATURE CONTROL

(71) Applicant: Nanjing University of Aeronautics and Astronautics, Nanjing (CN)

(72) Inventors: Leilei WANG, Nanjing (CN); Shaozhi GUAN, Nanjing (CN); Xiaohong ZHAN, Nanjing (CN); Qiyu GAO, Nanjing (CN); Yuchi FANG, Nanjing (CN); Hengchang BU, Nanjing (CN)

(73) Assignee: Nanjing University of Aeronautics and Astronautics, Nanjing (CN)

(21) Appl. No.: 18/915,209

(22) Filed: Oct. 14, 2024

(30) Foreign Application Priority Data
Jan. 5, 2024 (CN) 202410021278.0

(51) Int. Cl. B23K 26/03; B23K 26/70

(52) U.S. Cl. CPC B23K 26/034; B23K 26/703

(57) ABSTRACT

Disclosed are a laser manufacturing microstructure partition regulation and control device and a corresponding method based on matrix modular temperature control. An inner portion of the device's console provides a plurality of temperature regulation and control elements arranged in a matrix form so that a workpiece is divided into different areas. During the laser manufacturing process, the temperature of the workpiece is monitored in real-time via a temperature detector; a wireless communication device is used for feeding back the collected data to a computer; the computer judges whether the workpiece needs to be heated or cooled, then the signal is transmitted to the wireless communication device, and the console controls an induction coil or a cooling nozzle to perform partition regulation and control on the temperature of the workpiece according to the signal so that the workpiece has a specific temperature gradient from a cladding layer to a substrate direction.

### CROSS-REFERENCE TO RELATED APPLICATIONS

This application claims priority to Chinese Patent Application No. 202410021278.0, filed on Jan. 5, 2024, the content of which is incorporated herein by reference in its entirety.

### TECHNICAL FIELD

The present disclosure belongs to the field of laser manufacturing, and discloses a laser manufacturing microstructure partition regulation and control device and a laser manufacturing microstructure partition regulation and control method based on matrix modular temperature control.

### BACKGROUND

Laser manufacturing technology is one of the fundamental techniques for repairing damaged workpieces and has been extensively applied in significant national engineering sectors such as aerospace and shipbuilding. Laser manufacturing technology uses original parts as manufacturing blanks and uses laser manufacturing and forming technology to restore the size, shape and performance of parts, which is mainly used to repair parts and components. Laser manufacturing primarily involves irradiating high-energy-density laser beams, which melt powder and metallurgical surfaces, allowing them to rapidly solidify into coatings, thereby achieving manufacturing. Compared to traditional manufacturing processes, laser-based manufacturing boast advantages such as smaller heat-affected zones, superior metallurgical bonding, faster cooling rates, and less cracks, deformations, and dilutions. The following problems usually exist in the laser manufacturing process.

Firstly, due to the rapid heating rate of laser manufacturing, a large temperature gradient occurs along the direction from the cladding layer to the substrate. The rapid solidification rate also prevents the elements in the molten pool from homogeneous diffusion, resulting in uneven composition distribution in the cladding layer.

Secondly, the large temperature gradient between the substrate and the molten pool also leads to uneven sizes and varying morphologies of grain on both sides of the interface between the cladding layer and the substrate, further reducing mechanical properties.

Therefore, an urgent need is to invent a laser manufacturing microstructure partition regulation and control device and a laser manufacturing microstructure partition regulation and control method based on matrix modular temperature control to solve the problems mentioned above. According to the present disclosure, the workpiece is divided into different areas. The temperature partitioning control is achieved through an induction coil and cooling nozzle, aiming to regulate the temperature gradient along the direction from the cladding layer to the substrate. Real-time temperature monitoring of the workpiece is conducted using the temperature detector, allowing for continuous temperature adjustment to ensure uniform diffusion of elements in the molten pool and even distribution of composition in the cladding layer. Ultimately, the expected grain structure can be achieved.

### SUMMARY

The object of the present disclosure is to provide a laser manufacturing microstructure partition regulation and control device and a laser manufacturing microstructure partition regulation and control method based on matrix modular temperature control, and the temperature gradient in the laser manufacturing process is regulated and controlled in real time so that the workpiece can reach the expected grain structure.

To achieve the above objectives, the present disclosure adopts the following technical solutions.

A laser manufacturing microstructure partition regulation and control device based on matrix modular temperature control, comprises a detection and signal transmission device and a temperature regulation and control element.

The detection and signal transmission device comprises a console, an insulating substrate, a temperature detector and a wireless communication device; the wireless communication device is arranged in the console, the wireless communication device is used for wireless transmission with a computer, and the wireless communication device is used for receiving signals transmitted by the computer and feeding back data collected by the temperature detector, thereby realizing dynamic regulation and control of the substrate temperature; the insulating substrate is arranged above the console, the insulating substrate is used for placing a workpiece, an induction coil is arranged in the console, and the insulating substrate is not affected by the induction coil to generate current; and the temperature detector is arranged behind the console, the temperature detector is used for detecting the temperature of different areas of the insulating substrate, and the temperature detector is further used for feeding back data collected by the temperature detector to the computer, enabling zonal regulation of the substrate temperature.

The temperature regulation and control element comprises a magnetic field shielding ring, an induction coil and a cooling nozzle; a plurality of groups of temperature regulation and control elements are arranged in a groove of the console, and the plurality of groups of temperature regulation and control elements are placed in the groove in an n*n matrix form; and during the laser manufacturing process, the console is used for performing partition regulation and control on the temperature of the insulating substrate in a matrix form via signals received by the wireless communication device from the computer, the induction coil is used for heating the workpiece, and the cooling nozzle is used for cooling the workpiece so that the workpiece has a specific temperature gradient.

The induction coil is arranged in the magnetic field shielding ring, the magnetic field shielding ring is used for isolating a magnetic field influence between the induction coils, the material of the magnetic field shielding ring in a horizontal direction is a shielding material, the material of the magnetic field shielding ring in a vertical direction is an insulating material, the magnetic field shielding ring is arranged to shield a magnetic field generated by the induction coil in a horizontal direction, and is arranged to not shield a magnetic field generated by the induction coil in a vertical direction; the induction coil is connected with the console, and the induction coil is used for generating a magnetic field, so that a current is generated in a corresponding area of the substrate, and then the workpiece is heated; the cooling nozzle is arranged at a center of the magnetic field shielding ring, the cooling nozzle is connected with the console, a cooling medium is arranged in the cooling nozzle, the cooling medium is liquid nitrogen, and the cooling nozzle is used for spraying the cooling medium upward to cool the workpiece.

A laser is positioned above the console and is used for laser manufacturing of the insulating substrate.

Preferably, a laser manufacturing microstructure partition regulation and control method based on matrix modular temperature control comprises the following steps:
S1, before the laser manufacturing process, dividing an area of a workpiece, placing the workpiece on an insulating substrate, and turning on one of a plurality of temperature regulation and control elements corresponding to each region;
S2, before the laser manufacturing process, inputting a material parameter of the workpiece and a temperature gradient capable of forming an expected grain structure into a computer;
S3, turning on a laser to output a laser beam to repair the workpiece;
S4, during the laser manufacturing process, detecting the temperature of the workpiece using a temperature detector via a console, collecting the temperature data of the workpiece to a wireless communication device, and feeding back the temperature data to the computer;
S5, comparing a predetermined temperature gradient with the temperature data obtained by the temperature detector using the computer, and judging whether the temperature of a corresponding area exceeds a temperature range, and if the temperature exceeds the predetermined temperature range, judging whether the corresponding area should be heated or cooled, and generating a corresponding signal;
S6, transmitting a signal to the wireless communication device using the computer, performing partition regulation and control on the substrate via the console according to the signal, and conducting heating or cooling via the induction coil or the cooling nozzle so that a temperature gradient of the workpiece is kept within a preset range; and
S7, throughout the entire laser manufacturing process, the console continuously collects data and sends the data to the wireless communication device, which then feeds the data back to the computer, where the computer evaluates the temperature and continuously outputs signals to the console, enabling the temperature control elements in the corresponding regions to dynamically regulate the temperature gradient of the workpiece, all of these processes continue until the repair is completed, ultimately resulting in the desired grain structure.

Preferably, in S2, the input material for the workpiece is a material that generates current through induction heating, including aluminum, copper, iron, nickel, tin; and the input temperature gradient is arranged to control the grain to grow into a corresponding microstructure, which comprises equiaxed crystals or columnar crystals.

Preferably, in S5 and S6, the area for signal transmission is determined based on the scanning area of the laser, with both remaining synchronized, so that the console performs directional heating or cooling on the workpiece, thereby regulating a temperature gradient of a paste area of the whole workpiece and realizing the grain homogenization of the workpiece.

The beneficial effects of the present disclosure are as follows.

The present disclosure aims to provide a device and a method for zoning control of laser manufacturing tissue based on matrix modular temperature control. The method comprises the following steps: performing the partition regulation and control of the workpiece by utilizing a plurality of temperature regulation and control elements to control the temperature gradient of the workpiece so that the workpiece finally obtains the expected grain morphology. The uniformity of grain structures on both sides of the cladding layer and the substrate interface is improved, and the problem of uneven composition distribution of the cladding layer is solved.

### BRIEF DESCRIPTION OF THE DRAWINGS

FIG. 1 is a schematic structural diagram of a laser manufacturing microstructure partition regulation and control device based on matrix modular temperature control provided by the present disclosure after being cut open.

FIG. 2 is a schematic structural diagram of an overall structure of a laser manufacturing microstructure partition regulation and control device based on matrix modular temperature control provided by the present disclosure.

FIG. 3 is a schematic structural diagram of a temperature regulation and control element in a laser manufacturing microstructure partition regulation and control device based on matrix modular temperature control provided by the present disclosure.

FIG. 4 is a specific operation process provided by the present disclosure.

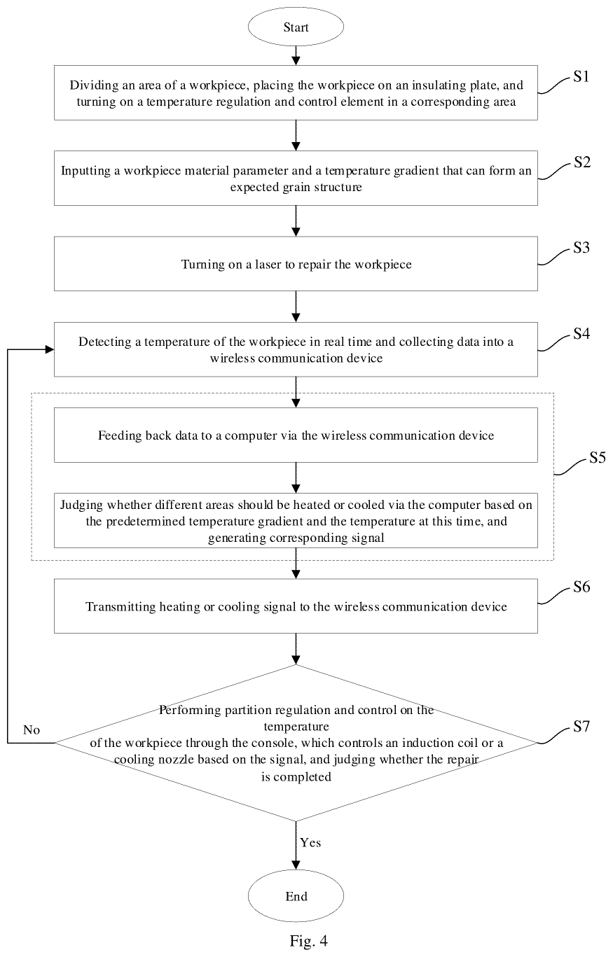

### DETAILED DESCRIPTION OF THE EMBODIMENTS

The present disclosure will be further described below with the accompanying drawings and specific embodiments. It can be understood that the particular embodiments described here are only used to explain the present disclosure, not to limit it. In addition, it should be noted that, for convenience of description, only some but not all structures related to the present disclosure are shown in the accompanying drawings.

In the description of the present disclosure, unless otherwise clearly stated and limited, the terms “connected with,” “connected to,” and “fixed” should be understood in a broad sense. For example, it can be a fixed connection, a detachable connection, or an integral connection; it can be a mechanical connection or an electrical connection; it can be a direct connection or an indirect connection through an intermediate medium; and it can be an internal communication between two elements or an interaction between two components. For those of ordinary skill in the art, the specific meanings of the above terms in the present disclosure can be understood on a case-by-case basis.

In the present disclosure, unless otherwise clearly stated and limited, the first feature “above” or “below” the second feature may include direct contact between the first feature and the second feature or may consist of contact between the first feature and the second feature through another feature between them instead of direct contact. Furthermore, the first feature being “above,” “over,” and “on top of,” the second feature includes the first feature being directly above and obliquely above the second feature or simply indicating that the first feature is horizontally higher than the second feature. The first feature is located “below,” “under,” and “beneath.” The second feature includes the first feature being directly below and obliquely below the second or simply indicating that the first feature is horizontally less than the second one.

In the description of the present disclosure, the orientation or positional relationship indicated by the terms “upper,” “lower,” “right,” and the like is based on the orientation or positional relationship shown in the drawings and is only for the convenience of describing and simplifying the operation. It is not intended to indicate or imply that the device or element referred to must have a specific orientation, be constructed and operate in a particular orientation. It, therefore, is not to be construed as a limitation of the present disclosure. In addition, “first” and “second” are only used for descriptive purposes and have no special meaning.

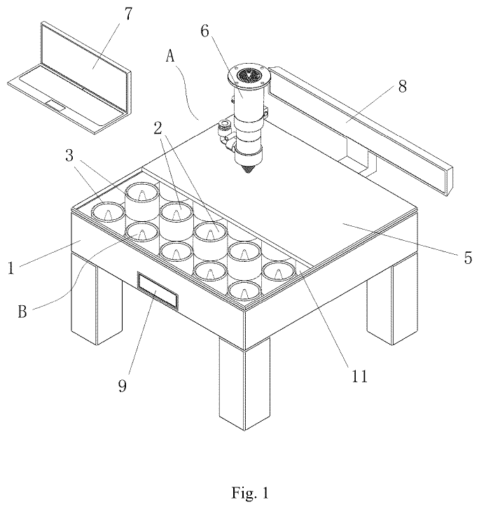

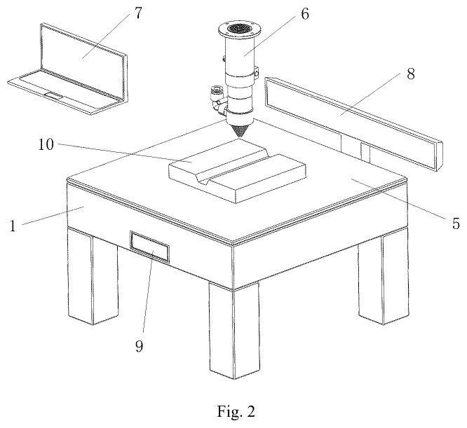

Specifically, as shown in FIGS. 1 and 2, a laser manufacturing microstructure partition regulation and control device based on matrix modular temperature control comprises a detection and signal transmission device A and a temperature regulation and control element B.

The detection and signal transmission device A includes a console 1, an insulating substrate 5, a laser 6, a computer 7, a temperature detector 8 and a wireless communication device 9. The wireless communication device 9 is arranged in console 1, the wireless communication device 9 is used for wireless transmission with the computer 7, the computer 7 transmits a signal to the wireless communication device 9, the wireless communication device 9 controls the induction coil 3, and the cooling nozzle 4 to adjust the temperature of a workpiece 10 according to the signal, and meanwhile, the wireless communication device 9 also collects temperature data detected by the temperature detector 8 and feeds back the temperature data back to the computer 7; the insulating substrate 5 for placing the workpiece 10 is arranged above the console 1; the temperature detector 8 is arranged behind the console 1, the temperature detector 8 is used for detecting the temperature of the workpiece 10, and the temperature of the workpiece 10 can be detected in real-time. The Laser 6 is positioned above console 1 and used for repairing workpiece 10.

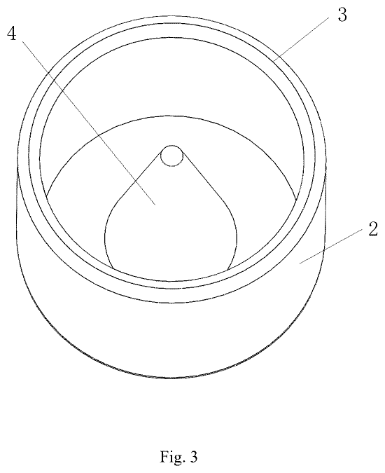

Specifically, as shown in FIG. 3, a magnetic field shielding ring 2 material in a horizontal direction is a shielding material used for shielding a magnetic field in the horizontal direction. A material in a vertical direction is only an insulating material, and the magnetic field of the induction coil 3 cannot be shielded. The induction coil 3 generates the magnetic field to generate current in a corresponding area of the workpiece 10, thereby heating the corresponding area of the workpiece 10. The cooling nozzle 4 is provided with a cooling medium, generally liquid nitrogen, and the corresponding area of workpiece 10 is cooled by spraying the cooling medium above.

The temperature regulation and control element B comprises a magnetic field shielding ring 2, an induction coil 3 and a cooling nozzle 4; a plurality of groups of temperature regulation and control elements B are arranged in groove 11 of console 1, and the plurality of groups of temperature regulation and control elements B are placed in the groove 11 in an n*n matrix form; and during the laser manufacturing process, the console 1 is used for performing partition regulation and control on the temperature of the workpiece 10 in a matrix form via signals received by the wireless communication device 9 from the computer 7, the induction coil 3 is used for heating the workpiece 10, and the cooling nozzle 4 is used for cooling the workpiece 10 so that the workpiece 10 has a specific temperature gradient.

A laser manufacturing microstructure partition regulation and control method based on matrix modular temperature control, comprising the following steps:
S1, before the laser manufacturing process, dividing an area of workpiece 10, placing workpiece 10 on an insulating substrate 5, and turning on one of a plurality of temperature regulation and control elements B corresponding to each region of workpiece 10;
S2, before the laser manufacturing process, inputting a material parameter of the workpiece 10 and a temperature gradient capable of forming an expected grain structure into a computer 7;
S3, turning on a laser 6 to output a laser beam to repair the workpiece 10;
S4, during the laser manufacturing process, detecting the temperature of the workpiece 10 using a temperature detector 8 via console 1, collecting the temperature data of the workpiece 10 to a wireless communication device 9, and feeding back the temperature data to the computer 7;
S5, comparing a predetermined temperature gradient with the temperature data obtained by the temperature detector 8 using computer 7, and judging whether the temperature of a corresponding area exceeds a temperature range, and if the temperature exceeds the predetermined temperature range, judging whether the corresponding area should be heated or cooled, and generating a corresponding signal;
S6, transmitting a signal to the wireless communication device 9 using the computer 7, performing partition regulation and control on the workpiece 10 via the console 1 according to the signal, conducting heating or cooling via the induction coil 3 or the cooling nozzle 4, so that a temperature gradient of the workpiece 10 is kept within a preset range; and
S7, throughout the entire laser manufacturing process, the console continuously collects data and sends the data to the wireless communication device, which then feeds the data back to the computer, where the computer evaluates the temperature and continuously outputs signals to the console, enabling the temperature control elements in the corresponding regions to dynamically regulate the temperature gradient of the workpiece, all of these processes continue until the repair is completed, ultimately resulting in the desired grain structure.

In S2, the input material for the workpiece 10 is a material that generates current through induction heating, including aluminum, copper, iron, nickel, tin; and the input temperature gradient is arranged to control the grain to grow into a corresponding microstructure, which comprises equiaxed crystals or columnar crystals.

In S5 and S6, the area for signal transmission of the temperature detector 8 is determined based on the scanning area of the laser 6, with both remaining synchronized, so that the console 1 performs directional heating or cooling on the workpiece 10, thereby regulating a temperature gradient of a paste area of the whole workpiece 10 and realizing the grain homogenization of the workpiece 10.

The embodiments mentioned above of the present disclosure are only examples for clearly illustrating the present disclosure and are not intended to limit the embodiment of the present disclosure. For those of ordinary skill in the art, various noticeable changes, readjustments and substitutions can be made without departing from the scope of the present disclosure. It is not necessary to exhaustively enumerate all embodiments herein. Any modifications, equivalent substitutions and improvements made within the spirit and principles of the present disclosure shall be included in the protection scope of the claims of the present disclosure.

What is claimed is:

1. A laser manufacturing microstructure partition regulation and control device based on matrix modular temperature control, comprising a detection and signal transmission device and a temperature regulation and control element; wherein
the detection and signal transmission device comprises a console, an insulating substrate, a temperature detector and a wireless communication device, the wireless communication device is arranged in the console, the wireless communication device is used for wireless transmission with a computer, and the wireless communication device is used for receiving signals transmitted by the computer and feeding back data collected by the temperature detector, thereby realizing dynamic regulation and control of the substrate temperature; the insulating substrate is arranged above the console, the insulating substrate is used for placing a workpiece, an induction coil is arranged in the console, and the insulating substrate is not affected by the induction coil to generate current; and the temperature detector is arranged behind the console, the temperature detector is used for detecting temperature of different areas of the insulating substrate, and the wireless communication device is further used for feeding back data collected by the temperature detector to the computer, thereby realizing the partition regulation and control of a temperature of the insulating substrate;
the temperature regulation and control element comprises a magnetic field shielding ring, an induction coil and a cooling nozzle; a plurality of groups of temperature regulation and control elements are arranged at the bottom of the groove in the console, and the plurality of groups of temperature regulation and control elements are placed in the groove in an n*n matrix form; during the laser manufacturing process, the console is used for performing partition regulation and control on the temperature of the insulating substrate in a matrix form via signals received by the wireless communication device from the computer, the induction coil is used for heating the workpiece, and the cooling nozzle is used for cooling the substrate so that the workpiece has a specific temperature gradient;
the induction coil is arranged in the magnetic field shielding ring, the magnetic field shielding ring is used for isolating a magnetic field influence between the induction coils, the material of the magnetic field shielding ring in a horizontal direction is a shielding material, the material of the magnetic field shielding ring in a vertical direction is an insulating material, the magnetic field shielding ring is arranged to shield a magnetic field generated by the induction coil in a horizontal direction, and is arranged to not shield a magnetic field generated by the induction coil in a vertical direction; the induction coil is connected with the console, and the induction coil is used for generating a magnetic field, so that a current is generated in a corresponding area of the substrate, and then the workpiece is heated; the cooling nozzle is arranged at a center of the magnetic field shielding ring, the cooling nozzle is connected with the console, a cooling medium is arranged in the cooling nozzle, the cooling medium is liquid nitrogen, and the cooling nozzle is used for spraying the cooling medium upward to cool the workpiece; and
a laser is positioned above the console and is used for laser manufacturing of the insulating substrate.

2. A laser manufacturing microstructure partition regulation and control method based on matrix modular temperature control according to claim 1, comprising the following steps:
S1, before the laser manufacturing process, dividing an area of a workpiece, placing the workpiece on an insulating substrate, and turning on one of a plurality of temperature regulation and control elements corresponding to each region;
S2, before the laser manufacturing process, inputting a material parameter of the workpiece and a temperature gradient capable of forming an expected grain structure into a computer;
S3, turning on a laser to output a laser beam to repair the workpiece;
S4, during the laser manufacturing process, detecting the temperature of the workpiece using a temperature detector via a console, collecting the temperature data of the workpiece to a wireless communication device, and feeding back the temperature data to the computer;
S5, comparing a predetermined temperature gradient with the temperature data obtained by the temperature detector using the computer, and judging whether the temperature of a corresponding area exceeds a temperature range, and if the temperature exceeds the predetermined temperature range, judging whether the corresponding area should be heated or cooled, and generating a corresponding signal;
S6, transmitting a signal to the wireless communication device using the computer, performing partition regulation and control on the substrate via the console according to the signal, and conducting heating or cooling via the induction coil or the cooling nozzle so that a temperature gradient of the workpiece is kept within a preset range; and
S7, throughout the entire laser manufacturing process, the console continuously collects data and sends the data to the wireless communication device, which then feeds the data back to the computer, where the computer evaluates the temperature and continuously outputs signals to the console, enabling the temperature control elements in the corresponding regions to dynamically regulate the temperature gradient of the workpiece, all of these processes continue until the repair is completed, ultimately resulting in the desired grain structure.

3. The laser manufacturing microstructure partition regulation and control method based on matrix modular temperature control according to claim 2, wherein in S2, the input material for the workpiece is a material that generates current through induction heating, including aluminum, copper, iron, nickel, tin; and the input temperature gradient is arranged to control the grain to grow into a corresponding microstructure, which comprises equiaxed crystals or columnar crystals.

4. The laser manufacturing microstructure partition regulation and control method based on matrix modular temperature control according to claim 2, wherein in S5 and S6, the area for signal transmission is determined based on the scanning area of the laser, with both remaining synchronized, so that the console performs directional heating or cooling on the workpiece, thereby regulating a temperature gradient of a paste area of the whole workpiece and realizing the grain homogenization of the workpiece.
